(19) United States
(12) Patent Application Publication
(10) Pub. No.: US 2012/0317780 A1
(43) Pub. Date: Dec. 20, 2012

(54) METHOD AND APPARATUS FOR CONNECTING THE FIRE EXTINGUISHING SYSTEM OF A MOBILE UNIT TO AN EXTERNAL MEDIUM SOURCE

(75) Inventor: Jarkko Malinen, Helsinki (FI)

(73) Assignee: Marioff Corporation OY, Vantaa (FI)

(21) Appl. No.: 13/518,555

(22) PCT Filed: Dec. 14, 2010
(86) PCT No.: PCT/FI2010/051020

§ 371 Date: Aug. 30, 2012

(30) Foreign Application Priority Data
Dec. 22, 2009 (FI) 20096384

(51) Int. Cl. B23P 11/00

(52) U.S. Cl. 29/428

(57) ABSTRACT

Method for joining the extinguishing system of a mobile unit (1), such as of a vehicle, a carriage connected to a vehicle, a railway vehicle or its carriage, such as a train or train carriage, to an external medium source, in which method a connecting part (7) is arranged in the extinguishing system of the mobile unit, and a counterpart (71) is outside the mobile unit, which parts are connected to each other. The counterpart (71) is arranged in a movable means (70), which is moved between at least one first position, a standby position, and one second position, a connection position, in which case the coupling is automatically formed between the connecting part (7) and the counterpart (71).

### BACKGROUND OF THE INVENTION

The object of the invention is a method as defined in the preamble of claim 1.

Another object of the invention is an apparatus as defined in the preamble of claim 12.

Fixed fire extinguishing systems for protecting stationary spaces are known from fire safety technology. On the other hand, extinguishing systems for protecting mainly the interior of a mobile unit, such as of rolling stock, are known in the art. One system is presented, among others, in publication WO 0126739. Publication EP1611925A1 presents another system for a mobile unit. Publication US2006038029 A presents a sprinkler system for rail vehicles. The publication states that external personnel, e.g. fire brigade, can pump water into a dry pipe and also to the spray nozzles through a coupling. Publication GB 2215204A presents a passenger carriage, in the extinguishing system of which are connections, from which the carriage system can be joined to an external extinguishing medium source.

A drawback of the mobile unit systems is that they typically give protection for rather a short time. They are also typically activated by activating a signal given by a fire detector inside the mobile unit or by manually activating the system from inside the unit. This is a problem particularly in situations, in which mobile units are temporarily out of service, e.g. at a carriage depot or station.

However, it is particularly the mobile units located at carriage depots or stations that have the highest risk of fire because various servicing work that can involve a higher risk of fire is performed there. A drawback with prior art solutions, with which the extinguishing system of rolling stock can be connected to an external extinguishing medium source is, among others, that people are needed to form the joint. The formation of the joint in this case is difficult and an expert is required to form the connection. On the other hand, in a situation in which a moving mobile unit is on fire the connection must be able to be formed quickly, e.g. at the nearest station.

The aim of this invention is to achieve a totally new type of solution, by means of which the fire protection level of mobile units can be essentially raised. Another aim of the invention is to achieve an automatic connection between mobile stock and the medium source.

### BRIEF DESCRIPTION OF THE INVENTION

The invention is based on a concept, in which each mobile unit provided with fire extinguishing means is automatically joined to an external medium source, preferably to the main line of a fixed extinguishing system, in which case it is within the sphere of enhanced fire protection.

The method according to the invention is mainly characterized by what is disclosed in claim 1.

The method according to the invention is also characterized by what is disclosed in claims 2-11.

The apparatus according to the invention is mainly characterized by what is disclosed in claim 12.

The apparatus according to the invention is also characterized by what is disclosed in claims 13-22.

The solution according to the invention has a number of significant advantages. The fire safety of a mobile unit can be substantially improved by automatically joining the mobile unit to an external medium source, preferably to the piping of a fixed extinguishing system. The mobile unit is thus protected by means of both the fixed fire extinguishing system of the station or of corresponding and also by means of the spray heads of the mobile unit itself. By using an automatic joint arrangement for joining the mobile unit to the fixed system, an easy-to-use and quick solution that enables the use of a pre-pressurized trunk pipe is achieved. By using in the joint a connecting part disposed in the mobile unit, which part can be activated, if needed, in a connection position and, on the other hand, a counterpart that is arranged to move along a trajectory, an inexpensive and operationally reliable arrangement for automatic forming of the joint is achieved.

### BRIEF DESCRIPTION OF THE FIGURES

In the following, the invention will be described in more detail by the aid of an example with reference to the attached drawing, wherein

FIG. 1 presents a diagrammatic view of one embodiment of a moving unit of an object of an apparatus according to the invention,

FIG. 2 presents a simplified and diagrammatic view of one embodiment of an object of an apparatus according to the invention,

FIG. 3 presents an embodiment of an apparatus according to the invention,

FIG. 3a presents a magnified detail A of FIG. 3,

FIG. 4 presents an embodiment of an apparatus according to the invention in the first phase,

FIG. 4a presents a magnified detail B of FIG. 4,

FIG. 5 presents an embodiment of an apparatus according to the invention in the second phase,

FIG. 5a presents a magnified detail C of FIG. 5,

FIG. 6 presents a side view of an embodiment of an apparatus according to the invention,

FIG. 6a presents a magnified and partially sectioned detail A of FIG. 6,

FIG. 7 presents a side view of an embodiment of an apparatus according to the invention,

FIG. 7a presents a magnified and partially sectioned detail B of FIG. 7,

FIG. 8 presents a side view of an embodiment of an apparatus according to the invention,

FIG. 8a presents a magnified and partially sectioned detail C of FIG. 8,

FIG. 9 presents a diagrammatic top view of an embodiment of the invention before the joint is formed, and

FIG. 10 presents a diagrammatic top view of an embodiment of the invention after the joint has been formed.

### DETAILED DESCRIPTION OF THE INVENTION

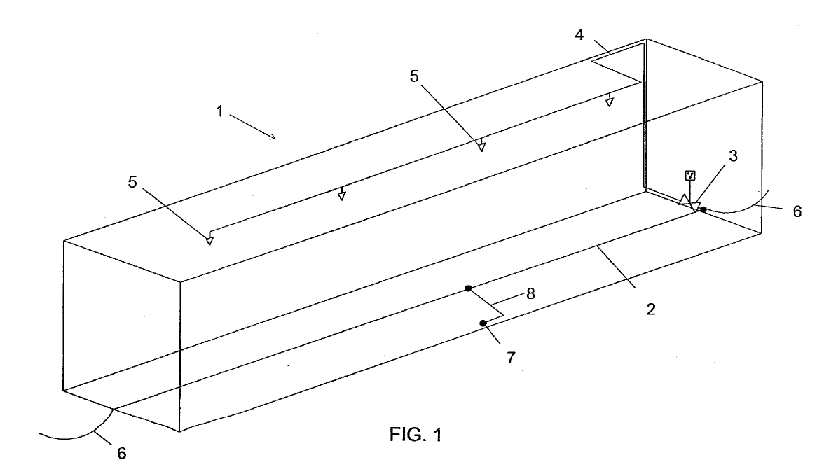

FIG. 1 presents a simplified view of a mobile unit 1 that is provided with an extinguishing system, which comprises at least spray nozzles 5 arranged in the interior of the unit, and also a pathway of the extinguishing medium, such as pipelines 4 from the extinguishing medium source to them. FIG. 1 presents one mobile unit 1 or a section thereof, such as a train carriage, which comprises one main transfer pipe 2 of the extinguishing medium, to which pipe the pipeline 4 leading to the nozzles is joined. In the embodiment of the figure, a valve means 3 is arranged in the pipeline leading to the nozzles. The main transfer pipe 2 is joined to the extinguishing medium source of the mobile unit 1, which source is not shown in FIG. 1. There can be a number of mobile units 1, such as train carriages, one after the other, in which case the sections of their fire protection systems can be joined to each other with a coupling part 6, such as with a flexible hose section. The extinguishing medium source of the mobile unit 1 can be located in another mobile unit, such as in another carriage, instead of in the space to be protected. According to a second embodiment, the mobile unit can be provided with only ready piping and spray heads, and can be without an extinguishing medium source of its own. In this case the mobile unit 1 is fire-protected only in situations, in which it is connected to an external medium source.

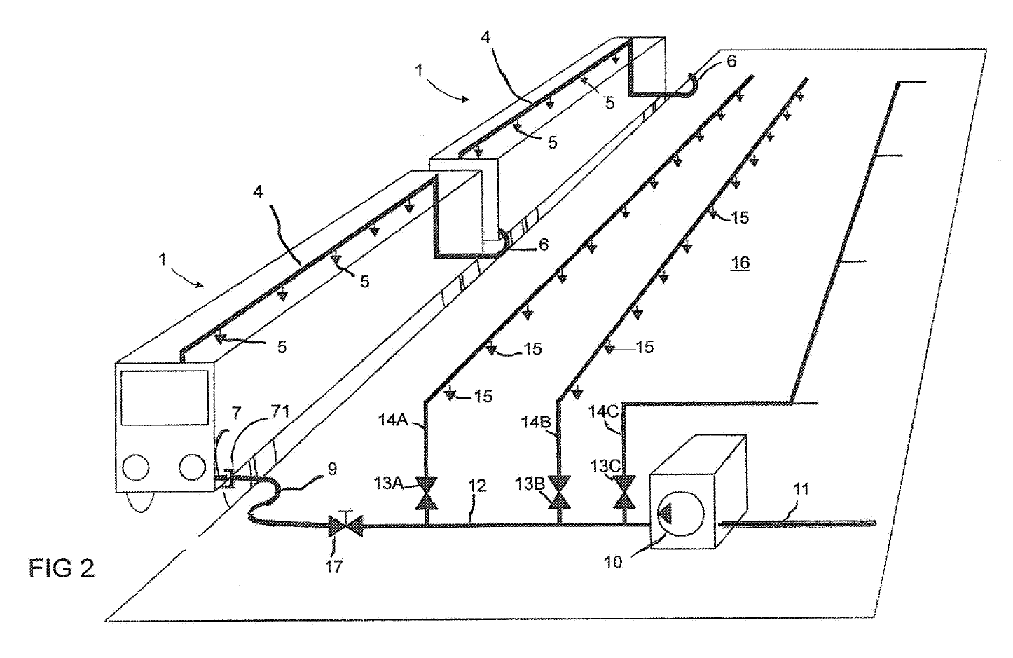

FIG. 2 presents a combination wherein the pathways 4 of the extinguishing medium leading to the spray nozzles 5 of the fire protection of the mobile unit 1, more particularly of its interior, are temporarily joined to a fixed supply cable 12 of an extinguishing system that is external with respect to the mobile unit 1. Naturally the fire extinguishing system also comprises an extinguishing medium source 11 and means for leading the extinguishing medium from the medium source to the trunk pipe 12 and, at least after the system has been activated, further to the spray heads 15. The medium source 11 is described in a simplified form. The means 10 used for transferring the medium, such as a pump means, is also presented in a simplified form.

In principle, the pump means 10 can be any appropriate pump means whatsoever. Alternatively, or in addition to the pump means, some other pressure source can also be used for supplying extinguishing medium.

In one preferred embodiment the means for supplying the extinguishing medium comprise a feature, by means of which a stand-by pressure can be maintained in the supply pipe 12 in a way that is known per se. When a liquid, or a mixture of a liquid and gas, is used as the extinguishing medium, the supply devices, such as pumps and pressure medium sources, of the extinguishing medium used in connection with the HI-FOG® extinguishing systems of Marioff Corporation Ltd can, for example, be used. The spray head, such as the sprinkler head, can be e.g. of the type presented in publication WO 01/45799, more particularly a spray head intended for producing liquid mist.

By the aid of an example, FIG. 2 presents two mobile units 1, such as rail traffic units, e.g. metro carriages, connected to each other that are parked and joined to the trunk pipe 12 via a flexible hose means 9 and a connecting unit 7, 71. In FIG. 2, a plurality of pipelines 14A, 14B, 14C leading to the protected areas, to which pipelines spray heads 15 have been joined, are joined to the trunk pipe 12 of the fixed extinguishing system. Each pipeline 14A, 14B, 14C is provided with a valve means 13A, 13B, 13C, i.e. with a so-called section valve.

The mobile units 1 comprise fire extinguishing means 2, 3, 4, 5, such as at least one spray head 5, more particularly a sprinkler head, and pipe means 2, 4, 6 for leading the extinguishing medium to the spray head. The extinguishing means are fitted to be joined as a part of a larger fixed extinguishing system, which extinguishing system comprises at least one trunk pipe 12 and at least one connection point 17 for joining the extinguishing means 4, 5 of the mobile unit to the trunk pipe, and also an extinguishing medium source 11 and means 12 for leading the extinguishing medium from the medium source to the spray head. A flexible hose 9 can be arranged at the connection point, which hose is joined at its second end with a counterpart 71 to the connection part 7 that is connected to the extinguishing means of the mobile unit.

An aqueous liquid, and/or a mixture of an aqueous liquid and gas, is typically used as the extinguishing medium. Extinguishing medium mist, particularly water mist, is sprayed with the spray heads. The droplet size (Dv 90) of the extinguishing medium mist is typically less than 200 micrometers.

The extinguishing medium is sprayed at high pressure, preferably at 10-300 bars. Typically, a pump unit comprising a constant pressure pump is used in connection with a fixed extinguishing system.

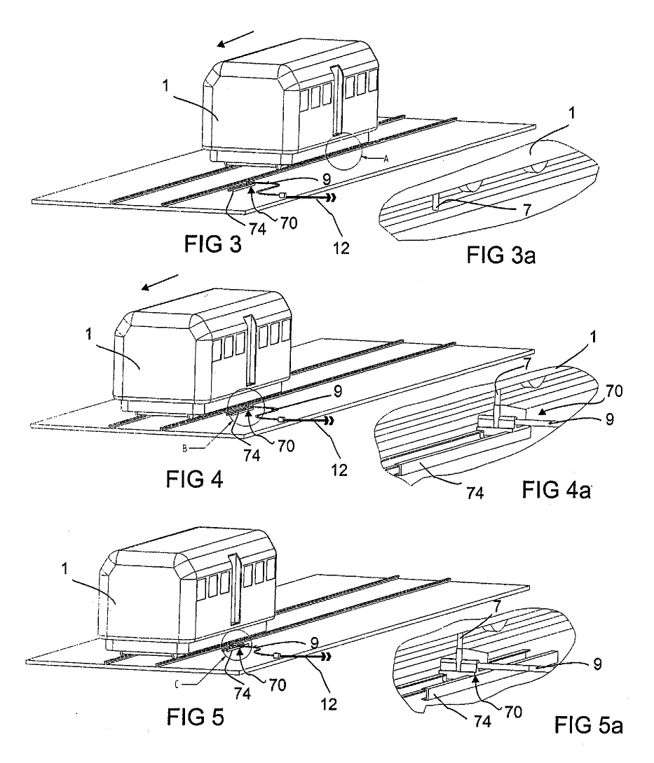

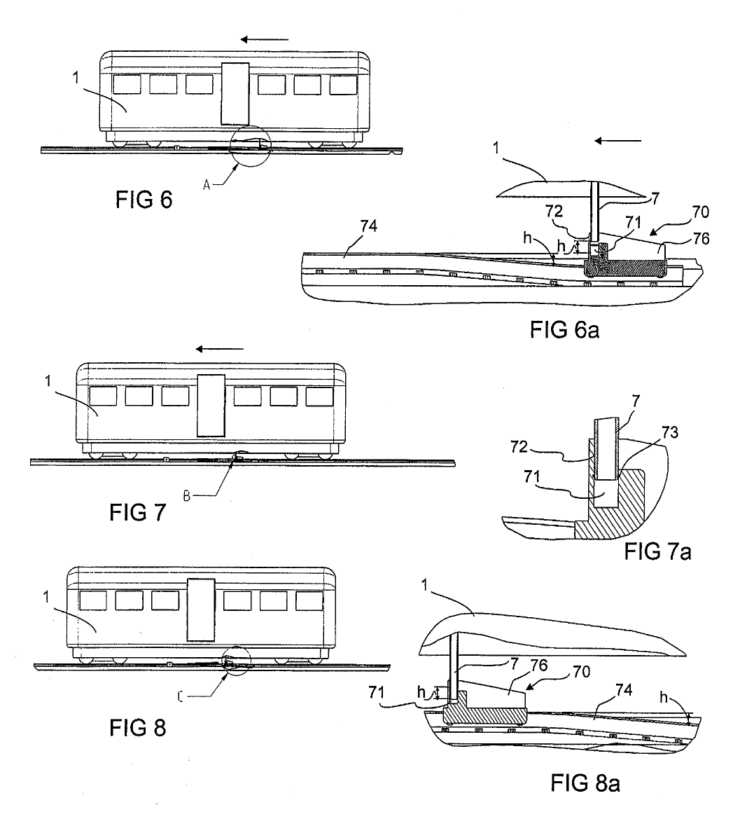

FIGS. 3-8 and 3a-8a present one preferred embodiment of the apparatus and of the method according to the invention. According to the embodiment, the mobile unit comprises a connecting part 7, which in the embodiment of the figures can be brought into a position in which it extends at a distance from the frame of the mobile unit or outwards from the walls. In the embodiments according to the figures, the connecting part 7 extends downwards from the frame of the mobile unit 1, however, at a distance from the pathway. It is conceivable that the connecting part could alternatively extend to the side or upwards. A counterpart 71 is arranged for the connecting part 7, which counterpart in the embodiment of FIGS. 3-8 and 3a-8a is arranged in a movable means 70, such as in a carriage. The movable means 70 and the counterpart 71 are arranged with a medium contact, such as with a flexible hose 9, with respect to the mobile unit 1, in the external medium source 11 (FIG. 2), either directly or via a trunk pipe 12. The movable means 70 and the counterpart 71 in it are arranged in a movable manner along a trajectory 74. The trajectory 74 is arranged in the proximity of the pathway of the mobile unit such that the connecting part 7 and the movable means can touch each other when the formation procedure of the joint is activated. The movable means 70 comprises a guide surface 72, 75, 76, which is arranged in the proximity of the counterpart 71. In the embodiment of the figures, the guide surface 72, 75, 76 extends at a distance from the counterpart to the meeting side of the connecting part 7 of the mobile unit 1. In this case in the activated position the connecting part 7 of the mobile unit extends to touch the guide surface 72 and at the same time, while the mobile unit is still moving, acts on the movable means and transfers it on the trajectory 74 in the direction of the arrow of FIG. 6a. In this case the connecting part 7 and the counterpart 71 are preferably directly facing each other. The trajectory 74 of the movable means approaches the connecting part 71 in the formation direction of the joint, in which case the connecting part 7 and the counterpart 71 form a joint when they connect to each other, as shown in FIG. 8a. The joint is formed by arranging the connecting part 7 into the aperture of the counterpart 71, from which aperture the medium pathway 9, 12 to the medium source 11 can be formed (FIG. 2). According to the invention, the coupling is typically formed in the stopping phase of the mobile unit, in which case when the joint is formed the mobile unit 1 is typically stopped. According to FIGS. 6a and 8a, the trajectory 74 approaches the connecting part of the mobile unit or its path of movement at a distance h from the first location of the moving means 70 to the second location of the moving means 70, which distance is the same distance h the connecting part 7 and the counterpart 71 move in relation to each other in the formation direction of the joint.

Correspondingly, it is conceivable that the connecting part 7 and the counterpart 71 are disconnected from each other when the trajectory 74 pulls away from the connecting part or its path of movement in the formation direction of the joint.

In one embodiment the invention functions as follows: When a fire is detected in a mobile unit 1 an alarm is given, e.g. from a fire detector or manually, in which case the connecting part 7 of the extinguishing system of the mobile unit is activated in the formation position of the coupling (in the bottom position in the figures). When the mobile unit approaches a place where it is possible to join the mobile unit to an external medium source, the connecting part touches the moving means, in which the counterpart is arranged and moves the moving means along its own trajectory 74, in which case the trajectory is formed to be such that the counterpart and the connecting part approach each other and a coupling is formed. The mobile unit 1 stops. In this case a connection from the medium source 11 through piping 12 via the coupling 7, 71 to the extinguishing system of the mobile unit can be opened.

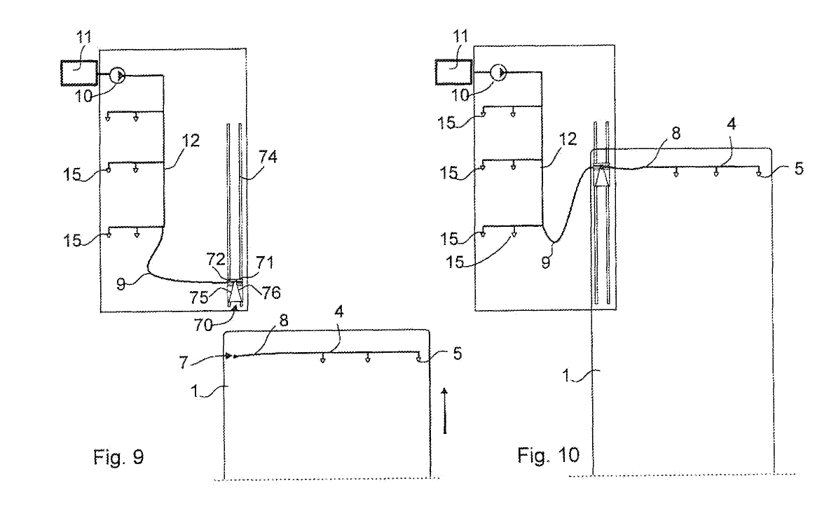

FIGS. 9 and 10 further present a diagrammatic top view of an apparatus according to the invention. In FIG. 9 before the joint is formed and in FIG. 10 after the joint is formed.

The invention thus relates to a method for joining the extinguishing system of a mobile unit 1, such as of a vehicle, a carriage connected to a vehicle, a rail vehicle or its carriage, such as a train or a train carriage, to an external medium source, in which method a connecting part 7 is arranged in the extinguishing system of the mobile unit, and a counterpart 71 is outside the mobile unit, which parts are connected to each other. The counterpart 71 is arranged in a movable means 70, which is moved between at least one first position, a standby position, and one second position, a connection position, in which case the coupling is automatically formed between the connecting part 7 and the counterpart 71.

According to one preferred embodiment the counterpart 71 is moved along the trajectory 74.

According to one preferred embodiment the connecting part 7 moves along with the mobile unit 1 when the joint is formed.

According to one preferred embodiment the connecting part 7 and/or the counterpart 71 are moved in relation to each other in the formation direction of the joint.

According to one preferred embodiment the formation direction of the joint is essentially transverse with respect to the direction of movement of the mobile unit 1.

According to one preferred embodiment the counterpart 71 is arranged in the carriage 70, which is moved in the proximity of the mobile unit 1.

According to one preferred embodiment the counterpart 71 is arranged in the carriage 70, which is moved by the mobile unit 1, e.g. by pushing with the connecting part 7.

According to one preferred embodiment at least one guide surface 72, 75, 76, is arranged in the proximity of the counterpart 71, with which guide surface the connecting part 7 and/or the counterpart 71 are guided in order to form a joint.

According to one preferred embodiment the carriage 70 of the counterpart 71 is moved along the trajectory 74, in which first location of the carriage the counterpart and the connecting part are in a standby position, and in the second location the counterpart and the connecting part have formed a joint.

According to one preferred embodiment the medium source 11 is the medium source of a fixed extinguishing system, in which case when the joint is formed at least one spray head 5 of the mobile unit 1 is joined as a part of the fixed extinguishing system.

According to one preferred embodiment a fire alarm or fire detection in the mobile unit 1 activates the formation of the coupling, e.g. by moving the connecting part 7 such that it touches at least one guide surface 72, 75, 76 arranged in the proximity of the counterpart 71.

The invention also relates to an apparatus for joining the extinguishing system of the mobile unit 1, such as of a vehicle, a carriage connected to a vehicle, a rail vehicle or its carriage, such as a train or train carriage, to an external medium source 11, which extinguishing system comprises at least one spray head 5 and piping 4 for leading the medium to at least one spray head, and also a connecting part 7, and in which a counterpart 71 is arranged in the external medium source directly or via a medium pathway, in which case the connecting part 7 of the mobile unit and the external counterpart 71 can be connected such that a medium pathway can be formed between the medium source and the extinguishing system of the mobile unit. The counterpart 71 outside the mobile unit is arranged in the movable means 70, which means can be moved between at least one first position, a standby position, and one second position, a connection position, in which case the coupling is automatically formed between the connecting part 7 and the counterpart 71.

According to one preferred embodiment the counterpart 71 is arranged in the movable means 70, which means is fitted to move along the trajectory 74.

According to one preferred embodiment the connecting part 7 is fitted to move along with the mobile unit 1 when the joint is formed.

According to one preferred embodiment the connecting part 7 and/or the counterpart 71 are fitted in a movable manner in relation to each other in at least the formation direction of the joint.

According to one preferred embodiment the formation direction of the joint is essentially transverse with respect to the direction of movement of the mobile unit 1.

According to one preferred embodiment the counterpart 71 is arranged in the carriage 70, which can be moved in the proximity of the mobile unit 1.

According to one preferred embodiment the counterpart 71 is arranged in the carriage 70, which is fitted to be moved by the mobile unit 1, e.g. via the connecting part 7, at least when the joint is formed.

According to one preferred embodiment at least one guide surface 72, 75, 76, is arranged in the proximity of the counterpart 71, which guide surface is fitted to guide the connecting part 7 and/or the counterpart 71 in order to form a joint.

According to one preferred embodiment the counterpart 71 is arranged in the carriage 70, which is fitted to be moved along the trajectory 74, in which case in the first location of the carriage the counterpart and the connecting part are in a standby position, and in the second location the counterpart and the connecting part have formed a joint.

According to one preferred embodiment the apparatus comprises means for activating the formation of the coupling, e.g. on the basis of the fire detection or fire alarm of the mobile unit.

According to one preferred embodiment the medium source 11 is the medium source of a fixed extinguishing system, in which case when the joint is formed at least a part of the spray heads 5 of the mobile unit 1 are joined as a part of the fixed extinguishing system, e.g. as a part of the extinguishing system of a traffic station, railway station or a metro station.

Some preferred embodiments are further presented in the following: The object of the invention is also a fire extinguishing system, which comprises a fixed extinguishing system with a plurality of spray heads 15 and also means 10, 12, 14A, 14B, 14C for leading the extinguishing medium from the extinguishing medium source 11 to the spray heads 15, and also at least one pump means 10 between the extinguishing medium source 11 and the spray heads 15, which system further comprises spray heads 5 arranged in a mobile unit 1, such as in a vehicle, in a carriage to be connected to a vehicle, in a train or a train carriage, and means 2, 4 for leading the extinguishing medium to the spray heads 5. The system comprises means 7, 71, 8, 9 for joining the spray heads 5 of the mobile unit 1 to the circuit of the fixed extinguishing system. According to one preferred embodiment the mobile unit 1 is a rail vehicle and/or a carriage connected to a rail vehicle, such as a metro and/or a metro carriage, or a train and/or a train carriage. According to one preferred embodiment the spray heads of the mobile unit 1 are joined to a pipeline 4 which, in an inactive state, is fitted to be a so-called dry pipe. According to one embodiment the fixed extinguishing system is arranged in a space where the mobile unit 1 is parked. Typically, the fixed extinguishing system is arranged in a space that is a tunnel, railway station, metro station, carriage depot or corresponding. According to yet another embodiment a flexible hose 9 or corresponding is arranged between the extinguishing system section of the mobile unit 1 and the fixed extinguishing system section.

According to another embodiment the extinguishing system section of the mobile unit and the fixed extinguishing system section are joined to each other by a quick-disconnect coupling 7, 71. According to yet another preferred embodiment the extinguishing system, while activated, is fitted to spray extinguishing medium mist, particularly water mist, or a mixture of water mist and gas. According to another preferred embodiment the mobile unit 1 comprises an independent extinguishing system, to the supply pipe 6 of the extinguishing medium of which the supply pipe 12 of the extinguishing medium of the fixed extinguishing system is fitted to be joined. According to yet another preferred embodiment the spray heads 5 of the mobile unit 1, while activated, are arranged to spray into the interior of the mobile unit 1.

The fire extinguishing system according to the invention can be applied in various contexts. Natural applications are, e.g. metro systems, in which a possibility to temporarily join a metro carriage to a fixed extinguishing system is formed in the extinguishing systems of stations and/or of tunnels. Of course, correspondingly the solution according to the invention can also be used in other similar objects, such as in connection with trains or other means of transportation.

Utilizing the system in a situation in which the mobile unit 1 is moving in a fire situation is also conceivable. In this case the connecting part 7 of the mobile unit 1 is in a position from which it can be joined to the counterpart 71. The mobile unit is stopped at the nearest coupling point, at which point according to the invention it is automatically joined by the joint of the parts, the connecting part 7 and the counterpart 71, to the fixed extinguishing system.

It is obvious to the person skilled in the art that the invention is not limited to the embodiments presented above, but that it can be varied within the scope of the claims presented below. The characteristic features possibly presented in the description in conjunction with other characteristic features can, if necessary, also be used separately to each other.

1. A method for joining an extinguishing system of a mobile unit (1), such as of a vehicle, a carriage connected to a vehicle, a rail vehicle or its carriage, such as a train or train carriage, to an external medium source, in which method a connecting part (7) is arranged in the extinguishing system of the mobile unit, and a counterpart (71) is outside the mobile unit, which parts are connected to each other, wherein the counterpart (71) is arranged in a movable means (70), the method comprising:
moving the movable means from standby position to a connection position, wherein in in the connection position a coupling is automatically formed between the connecting part (7) and the counterpart (71).

2. The method according to claim 1, wherein moving comprises:
moving the counterpart (71) along a trajectory (74).

3. The method according to claim 1, further comprising:
moving the connecting part (7) along with the mobile unit (1) when the coupling is formed.

4. The method according to claim 1, wherein moving comprises:
moving the connecting part (7) and/or the counterpart (71) in relation to each other in the formation direction coupling.

5. The method according to claim 4, wherein the formation direction of the coupling is essentially transverse with respect to the direction of movement of the mobile unit (1).

6. The method according to claim 1, wherein the counterpart (71) is arranged in the carriage (70), and further comprising:
moving the carriage into proximity of the mobile unit (1).

7. The method according to claim 1, wherein the counterpart (71) is arranged in the carriage (70), and further comprising:
moving the carriage, by the mobile unit (1), by pushing with the connecting part (7).

8. The method according to claim 1, wherein at least one guide surface (72, 75, 76) is arranged in the proximity of the counterpart (71), and further comprising:
guiding, using the guide surface, the connecting part (7) and/or the counterpart (71) in order to form the coupling.

9. The method according to claim 2, further comprising:
moving the carriage (70) of the counterpart (71) along the trajectory (74), wherein in a first location of the carriage, the counterpart and the connecting part are in a standby position, and in a second location, the counterpart and the connecting part have formed a joint.

10. The method according to claim 1, wherein the external medium source (11) a medium source of a fixed extinguishing system, and comprising:
forming the coupling such that at least one spray head (5) of the mobile unit (1) is joined as a part of the fixed extinguishing system.

11. The method according to claim 1, that further comprising:
activating, by a fire alarm or fire detection in the mobile unit (1), formation of the coupling, by moving the connecting part (7) such that the connecting part (7) touches at least one guide surface (72, 75, 76) arranged in proximity of the counterpart (71).

12. An apparatus for joining an extinguishing system of a mobile unit (1), such as of a vehicle, a carriage connected to a vehicle, a rail vehicle or its carriage, such as a train or train carriage, to an external medium source (11) containing a medium, which extinguishing system comprises:
at least one spray head (5);
piping (4) for leading the medium to the at least one spray head;
a connecting part (7);
a counterpart (71) arranged to connect directly or via a medium pathway to the external medium source;
wherein the connecting part (7) of the mobile unit and the counterpart (71) can be connected such that a medium pathway between the external medium source and the extinguishing system of the mobile unit can be formed; and
wherein the counterpart (71) is outside the mobile unit and is arranged to be moved between at least a standby position, and a connection position, wherein in the connection position a coupling is automatically formed between the connecting part (7) and the counterpart (71).

13. The apparatus according to claim 12, wherein the counterpart (71) is arranged in a movable means (70), which movable means is fitted to move along a trajectory (74).

14. The apparatus according to claim 12, wherein the connecting part (7) is fitted to move along with the mobile unit (1) when the coupling is formed.

15. The apparatus according to claim 12, wherein the connecting part (7) and/or the counterpart (71) are fitted in a movable manner in relation to each other in at least a formation direction of the coupling.

16. The apparatus according to claim 15, wherein the formation direction of the joint coupling is essentially transverse with respect to the direction of movement of the mobile unit (1).

17. The apparatus according to claim 12, wherein the counterpart (71) is arranged in the carriage (70), which can be moved in the proximity of the mobile unit (1).

18. The apparatus according to claim 12, wherein the counterpart (71) is arranged in the carriage (70), which is fitted to be moved, at least when the coupling is formed, by the mobile unit (1) via the connecting part (7).

19. The apparatus according to claim 12, wherein at least one guide surface (72, 75, 76) is arranged in the proximity of the counterpart (71), wherein the at least one guide surface is fitted to guide the connecting part (7) and/or the counterpart (71) in order to form a joint.

20. The apparatus according to claim 12, wherein the counterpart (71) is arranged in the carriage (70), which is fitted to be moved along a trajectory (74),
wherein in a first position of the carriage the counterpart and the connecting part are in a standby position, and in the second position the counterpart and the connecting part have formed a joint.

21. The apparatus according to claim 12, wherein the apparatus comprises means for activating the formation of the coupling on the basis of a fire detection or fire alarm of the mobile unit.

22. The apparatus according to claim 12, wherein the external medium source (11) is a medium source of a fixed extinguishing system, and wherein when the coupling is formed the at least one spray head of the mobile unit (1) is joined as a part of the fixed extinguishing system.
